(19) United States
(12) Patent Application Publication
(10) Pub. No.: US 2003/0221532 A1
(43) Pub. Date: Dec. 4, 2003

(54) Horizontal meat slicer with butterfly blade

(76) Inventors: John W. Long, Omaha, NE (US); Henry Biggs, Gallatin, TN (US); Steve Korteley, Gallatin, TN (US)

Correspondence Address: LAW OFFICES OF ADAM H. JACOBS, SUITE 726, 1904 FARNAM STREET, OMAHA, NE, 68102, US

(21) Appl. No.: 10/339,868

(22) Filed: Jan. 11, 2003

Related U.S. Application Data
(63) Continuation of application No. 09/699,713, filed on Oct. 30, 2000, now abandoned.
(60) Provisional application No. 60/162,039, filed on Oct. 28, 1999.

(51) Int. Cl. B26D 1/00

(52) U.S. Cl. 83/651

(57) ABSTRACT

A horizontal meat slicer includes a frame and a lower conveyor belt having forward and rearward ends, the lower conveyor belt operative to receive a meat product thereon and transport it into and through the device. An upper pressing conveyor belt includes forward and rearward ends, the upper pressing conveyor belt and the lower conveyor belt cooperating such that meat product is compressed between the lower conveyor belt and the upper pressing conveyor belt. A rotating blade is mounted on the frame, the rotating blade having a cutting edge interposed between the lower conveyor belt and the upper pressing conveyor belt. Finally, at least one drive device such as a motor is operatively connected to each of the conveyor belts and the rotating blade to drive them to pull the meat product through the device and cut the meat product via the cutting edge of the blade.

### CROSS-REFERENCE TO RELATED APPLICATION

This continuation application claims priority to the filing date of related patent application Ser. No. 09/699,713 filed on Oct. 30, 2000 and to related provisional application serial No. 60/162,039 filed Oct. 28, 1999.

### BACKGROUND OF THE INVENTION

1. Technical Field

The present invention relates to meat slicing machines and, more particularly, to a horizontal meat slicing machine which includes upper and lower conveyor belt mechanisms which cooperate to transport meat product through the machine, at least one generally horizontal slicing blade interposed between the upper and lower conveyor belts for slicing meat product transported therethrough and height adjustment mechanisms for the blade and upper conveyor belt which will permit various types of cuts to be made in different types of meat products.

2. Description of the Prior Art

The cutting and processing of meat products can be a very hazardous occupation due to the various blades and saws which must be used. Each year, thousands of man-hours are lost to injuries sustained by meat packing plant workers, which causes great loss to the meat packing company, let alone the physical damage the employee suffers. Therefore, it has long been a desire of the meat packing industry to invent and use processing devices that substantially lessen or eliminate the possibility of injury to operators of those devices.

Two of the most dangerous devices are the bandsaw meat cutter and the butterfly slicing machine, due to the need for an operator of the machine to manually feed the meat product being cut into the device to contact the cutting blade. Obviously, if the operator is pressing the meat product into contact with the rapidly rotating blade, one slip is all that is needed to result in extremities being severed from or horrific cuts being made to the operator's body. Various devices have been proposed in the prior art to feed the meat product into contact with the cutting blades, but each of these includes at least one inherent shortcoming which does not fully address the problem presented. There is therefore a need for a horizontal meat slicer which automatically feeds the meat product into contact with the cutting blade without requiring the operator to manually press the meat product into contact with the cutting blade.

Therefore, an object of the present invention is to provide an improved horizontal meat slicer.

Another object of the present invention is to provide an improved horizontal meat slicer which includes at least one rotating cutting blade operative to cut meat product being fed into the device.

Another object of the present invention is to provide an improved horizontal meat slicer which includes upper and lower conveyor belts which feed the meat product through the slicer and substantially prevent accidental rotation of the meat product during the cutting process.

Another object of the present invention is to provide an improved horizontal meat slicer which includes a bandsaw type blade for cutting the meat product.

Another object of the present invention is to provide an improved horizontal meat slicer which includes a generally circular meat slicing butterfly blade operative to partially sever the meat product thereby butterflying the meat product for further processing.

Finally, an object of the present invention is to provide an improved horizontal meat slicer which is relatively simple and inexpensive in construction and is safe and effective in use.

### SUMMARY OF THE INVENTION

The present invention provides a horizontal meat slicer that includes a frame and a lower conveyor belt having forward and rearward ends, the lower conveyor bolt mounted on the frame for receiving a meat product thereon and transporting it into and through the device. An upper pressing conveyor belt includes forward and rearward ends, the upper pressing conveyor belt mounted on the frame spaced from and above the lower conveyor belt, the upper pressing conveyor belt and the lower conveyor belt cooperating such that when a meat product on the lower conveyor belt is transported into the device, the meat product is compressed between the lower conveyor belt and the upper pressing conveyor belt. A rotating blade is mounted on the frame, the rotating blade having a cutting edge interposed between the lower conveyor belt and the upper pressing conveyor belt such that as the meat product is moved past the cutting edge of the rotating blade, the meat product is cut by the cutting edge of the rotating blade. Finally, at least one drive device such as a motor is operatively connected to each of the conveyor belts and the rotating blade to drive each of the conveyor belts and the rotating blade to pull the meat product through the device and cut the meat product where the cutting edge of the blade contacts the meat product.

The present invention addresses and corrects many of the disadvantages found in the prior art. For example, the use of a rotating blade for cutting improves the quality of the cut being made, as the cut dynamics do not rely solely on the motion of the meat product to make the cut. Furthermore, the use of the upper and lower conveyor belts substantially eliminates the concern of the meat product accidentally twisting or rotating during the cutting process due to the “sandwiching” of the meat product therebetween. Also, as the present invention contemplates the use of both bandsaw-type blades and circular butterfly slicing blades, several variations of cutting the meat product can be performed by the present invention. It is therefore seen that the present invention provides a substantial improvement over those devices found in the prior art.

### BRIEF DESCRIPTION OF THE DRAWINGS

FIG. 1 is a perspective view of the horizontal slicer of the present invention;

FIG. 2 is a side elevational view of the present invention showing the height adjustment of the upper conveyor belt;

FIG. 3 is an end elevational view of the present invention;

FIG. 4 is a detail perspective view of the band saw blade assembly of the present invention;

FIG. 5 is a detail perspective view of one of the blade guide blocks guiding the band saw blades;

FIG. 6 is a perspective view of an alternative embodiment of the horizontal slicer of the present invention;

FIG. 7 is a detail top plan view of the alternative embodiment of the present invention; and

FIG. 8 is a side elevational view of the alternative embodiment of the present invention.

### DESCRIPTION OF THE PREFERRED EMBODIMENT

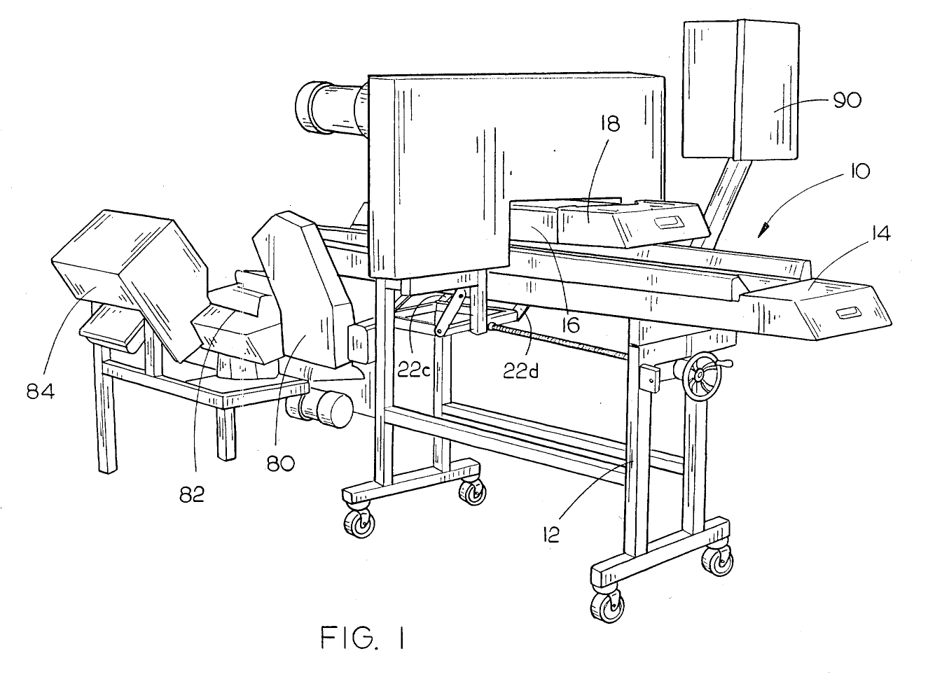

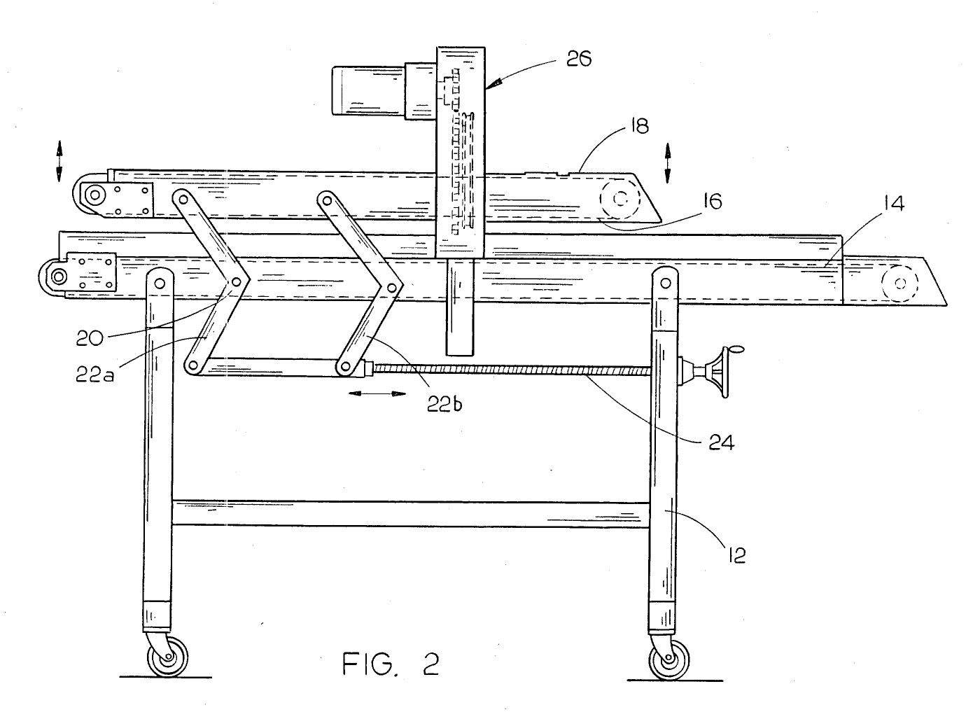

The horizontal meat slicer 10 of the present invention is shown best in FIGS. 1-5 as including a frame 12 on top of which is mounted a generally horizontal lower conveyor belt 14. As shown in FIGS. 1 and 2, belt 14 would preferably have a length of approximate seven to nine (7 to 9) feet, a width of approximately 12 to 18 inches and be constructed of a flexible rubber compound which is simple to clean and is durable in construction. Movably mounted above lower conveyor belt 14 and extending generally parallel therewith is an upper pressing conveyor belt 16 which extends parallel with and is adjustably spaced from lower conveyor belt 14. The upper pressing conveyor belt 16 is preferably mounted underneath a housing 18 which prevents accidental touching of the upper conveyor belt 16, thus preventing injury. Upper conveyor belt 16 and lower conveyor belt 14 cooperate to “sandwich” meat product placed therebetween and secure the meat product from movement during the slicing process other than the forward movement dictated by the rotation of lower and upper conveyor belts 14 and 16. It should thus be noted that lower and upper conveyor belts 14 and 16 move at the same speed with the lower conveyor belt 14 rotating in a counterclockwise direction from the vantage point of FIG. 1 while upper conveyor belt 16 rotates in a clockwise direction from the same vantage point.

The height of upper conveyor belt 16 may be adjusted in various ways, however, a preferred adjustment method is shown in FIG. 2 as including an upper conveyor belt mounting structure 20 which includes arms 22a, 22b, 22c, and 22d. The arms 22a-d are pivotably mounted on the frame 12 and furthermore are operatively connected to a rotatable threaded rod 24 which extends and retracts thus pivoting arms 22a-d and raising and lowering upper conveyor belt 16 and housing 18 accordingly. It is also contemplated and preferred that the upper conveyor belt 16 be mounted with tensioning devices operatively connected between the upper conveyor belt 16 and the frame 12 that act to draw the upper and lower conveyor belts 14 and 16 towards one another thereby pressing the meat product therebetween and securing it from twisting or rotation thereof.

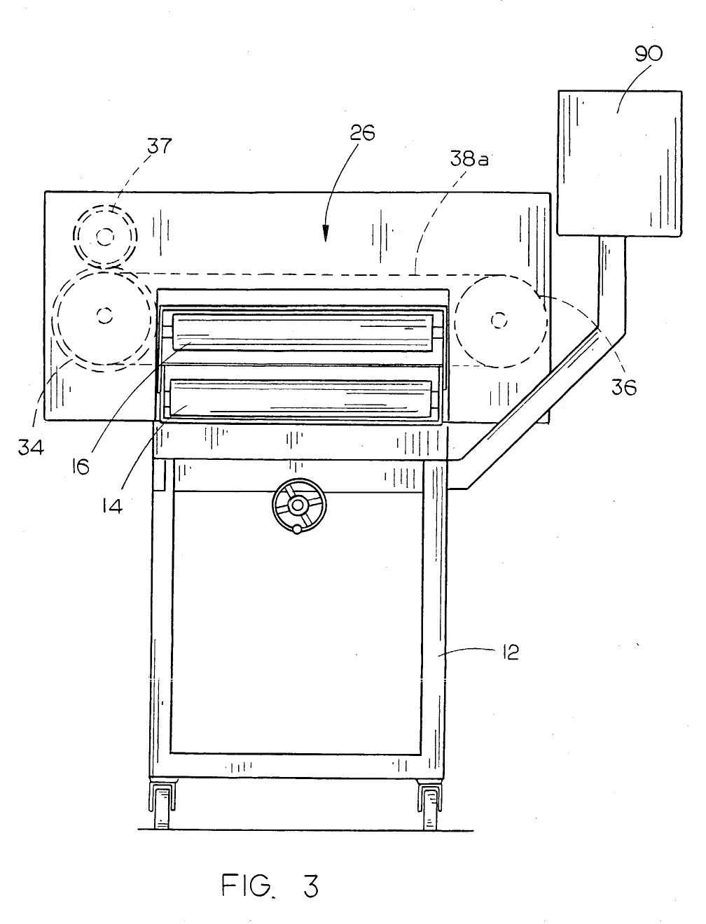

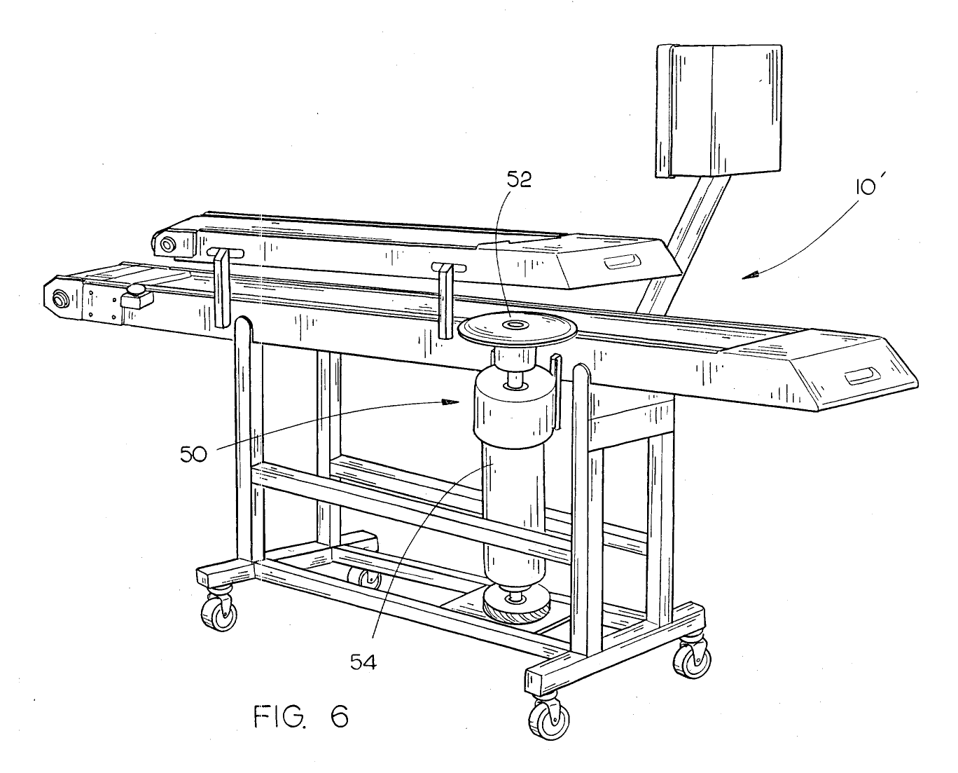

The cutting device of the present invention is a rotating blade which may be of several different types. The rotating blade is used to ensure quick and accurate cutting of the meat product as the meat product is moved through the horizontal meat slicer 10. FIGS. 2-5 best disclose a first embodiment of the cutting blades of the present invention, which bears a passing resemblance to a bandsaw type of cutting device. The band saw blade cutting assembly 26 is shown best in FIG. 2 as including a first blade support wheel 34 also known as a drive wheel, a second blade support wheel 36, a drive motor 37 connected to the first blade support wheel 34 and a tension adjustment mechanism 42. Extending around the first blade support wheel 34 and second blade support wheel 36 are one or more bandsaw blades 38a and 38b, shown best in FIGS. 2 and 3. Each bandsaw blade 38a and 38b is mounted on the wheels 34 and 36 on one or more blade steps 40a and 40b. It should be noted that the present invention may be used with a single band saw blade 38a or with multiple band saw blades 38a and 38b depending on the intended cuts to be made to the meat product, all of which fall within the intended broad scope of this disclosure. Also, for clarity purposes the blade steps 40a and 40b are shown only on first blade support wheel 34, specifically in FIG. 6, but is to be understood by reference to FIG. 2 that both the first blade support and second blade support wheels 34 and 36 may each include blade steps similar to that described in connection with first blade support wheel 34. In the preferred embodiment, the blade steps 40a and 40b would consist of concentric disks having progressively smaller diameters, each of the blade steps 40a and 40b supporting one of the saw blades 38a and 38b. The band saw blades 38a and 38b extend around the outer circumference of each of the wheels 34 and 36 and the lowermost sections of the band saw blades 38a and 38b extend generally horizontally between first blade support wheel 34 and second blade support wheel 36 between lower and upper conveyor belts 14 and 16. When the drive motor 37 is engaged, it drives first blade support wheel 34 to rotate, and the band saw blades 38a and 38b rotate with the first blade support wheel 34 and the second blade support wheel 36, and thus are ready and positioned to cut meat product being propelled through the horizontal meat slicer 10 via lower and upper conveyor belts 14 and 16.

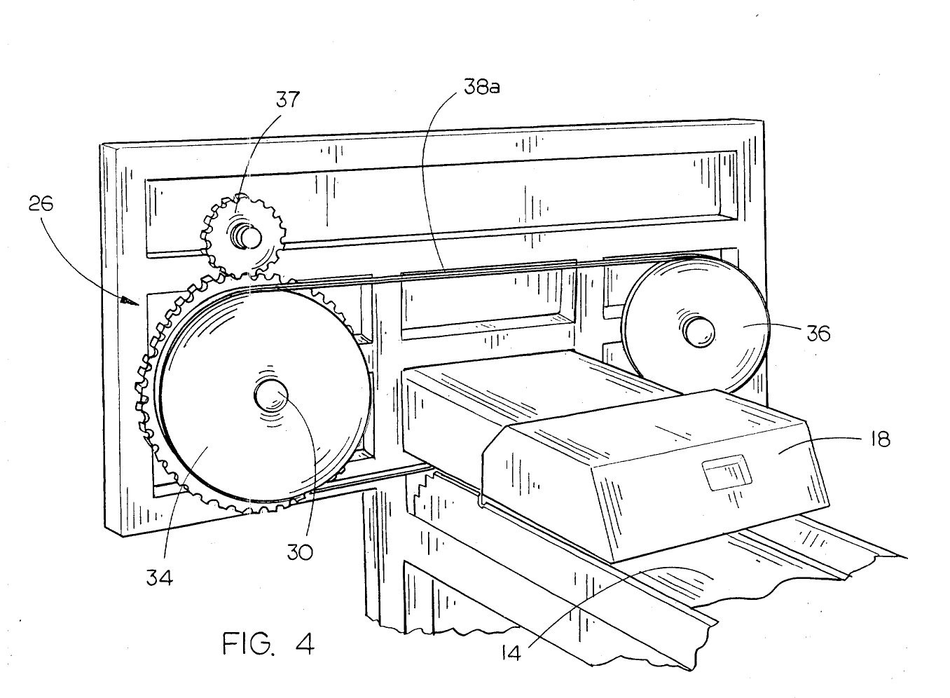

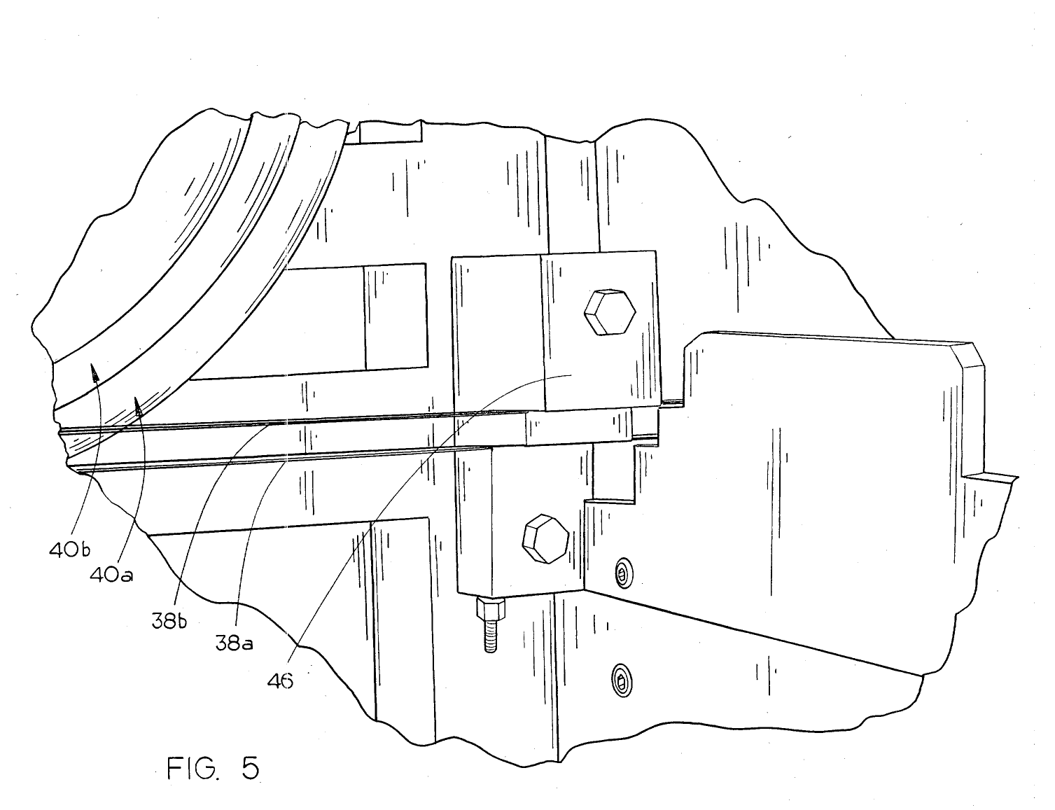

A blade tension adjustment device 30 is shown best in FIG. 4 as providing an adjustment mechanism for the tensioning of band saw blades 38a and 38b. It has been found that such tensioning may be necessary in connection with the blades encountering the meat product due to the stresses placed on the band saw blades 38a and 38b during the cutting process. The tension adjustment device 30 used in the present invention would preferably operate by shifting the position of the related band saw blade 38a and 38b relative to its normal travel position, thereby increasing the tension on the saw blade. During the cutting of various types of meat product, such tension adjustment devices are quite necessary to insure proper cutting of the meat product. Finally, it has been found to be advantageous to provide blade guides 46, shown best in FIG. 5, which are positioned on opposite sides of the conveyor belts 14 and 16 adjacent the travel location of the band saw blades 38a and 38b for guiding the band saw blades 38a and 38b and properly positioning the band saw blades to insure accurate cutting of meat product being fed through the horizontal meat slicer 10 of the present invention. In the preferred embodiment, the blade guide would be constructed of a Teflon coated material which would be long lasting and durable.

An alternative embodiment of the rotating blade of the present invention is shown in FIGS. 6-8 as including a butterfly blade assembly 50 which includes a generally circular meat slicing butterfly blade 52 which is mounted on a drive motor 54 mounted on the frame 12. The only differences between the alternative embodiment of FIGS. 6-8 and the embodiment described and shown in connection with FIGS. 1-5 are those connected with the substitution of the butterfly blade assembly 50 for the band saw blade cutting assembly 26. The arrangement and design of the conveyor belts, conveyor mounts and drive mechanisms therefor are substantially identical.

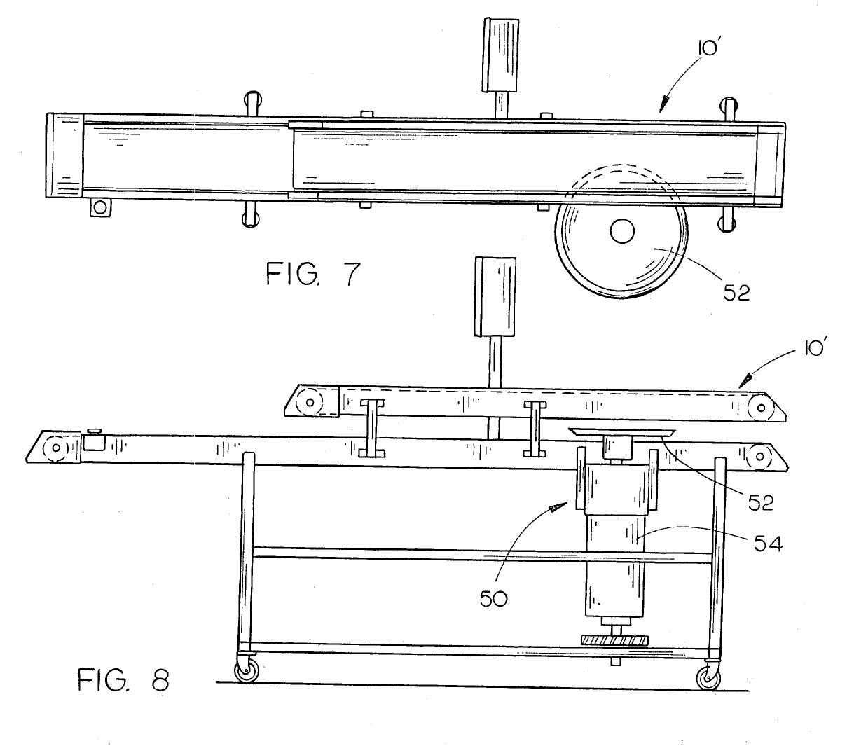

In this embodiment, the butterfly blade 52 of butterfly blade assembly 50 would preferably consist of a generally circular planar saw blade having saw teeth formed on the outer circumference thereof, the saw blade being concentrically mounted on the drive shaft 56 of drive motor 54 as shown best in FIG. 8. The blade 52 extends generally horizontally from the drive shaft 56 and is positioned such that the blade is interposed between the upper pressing and lower conveyor belts 16 and 14 and extends over a section of lower conveyor belt 14, as shown best in FIG. 7. When drive motor 54 is engaged, the drive shaft 56 is rotated at a high rate of speed and butterfly blade 52 rotates therewith such that meat product encountering butterfly blade 52 is sliced in a plane defined by the blade 52. The butterfly slicing blade 52 extends outwards into the travel area of the meat product 100 such that as the meat product 100 travels through the slicer via the lower and upper conveyor belts 14 and 16, it encounters the blade 52. Due to the offset of the blade 52 from the meat product 100, the meat product 100 is only partially severed along the plane of the blade such that one section of the meat product 100 remains intact. The meat product 100 is then removed from the horizontal meat slicer 10′ and has been “butterflied” for further processing.

The horizontal meat slicer 10 of the present invention is operated in the following manner. A meat product such as a pork butt or the like would be placed on the lower conveyor belt 14 and lower conveyor belt 14 would be engaged by a standard belt drive device (not shown) to commence to feed the meat product towards the blade assembly 26. The control box 90 includes the on/off switch and other controls for the present invention, each of which would be understood by one skilled in the art. The meat product would then be engaged by upper conveyor belt 16 and lower and upper conveyor belts 14 and 16 would cooperate to compress the meat product between the belts thus preventing unintentional rotation of the meat product during the cutting process. The conveyor belts 14 and 16 would move the meat product into engagement with the band saw blade or blades 38a and 38b or the butterfly blade 52 which are rotating at a high rate of speed to ensure accurate, clean cutting of the meat product. As the conveyor belts 14 and 16 move the meat product forward, the meat product is cut in the planes defined by the horizontal locations of the band saw blades 38a and 38b or the butterfly blade 52 and due to the compression provided by the lower and upper conveyor belts 14 and 16, the meat product does not separate, thus ensuring continued accurate cutting along the planes defined by the band saw blades 38a and 38b or the butterfly blade 52. As the meat product moves entirely through the horizontal meat slicer 10 it has been cut horizontally along the locations of the band saw blades 38a and 38b or the butterfly blade 52 and as the end of upper conveyor belt 16 is reached, the meat product is moved into the removal area of the end of lower conveyor belt 14 for further processing.

Regarding such further processing, various types of finishing devices could be included with the present invention, such as an interleaver 80, dicer assembly 82 or a slitter 84, the operation of which would be understood by those skilled in the art of meat processing.

It is to be understood that numerous modifications and substitutions may be made to the present invention which fall within the intended broad description of the invention. For example, the precise design layout of the horizontal meat slicer 10 of the present invention may be modified so long as the intended functioning of the invention is not disrupted. Furthermore, the blade assembly 26 may be modified or changed as needed to permit the cutting of various sized and shaped meat products. Finally, although it is preferred that the structural elements of the present invention be constructed generally of stainless steel and the conveyor belts of a rubber compound, it should be noted that various types of materials for construction may be used so long as the functionality of the present invention is not diminished.

There has therefore been shown and described a horizontal meat slicer which accomplishes at least all of its intended objectives.

I claim:

1. A horizontal meat slicer comprising:
a frame having forward and rearward ends;
an lower conveyor belt having forward and rearward ends, said lower conveyor bolt mounted on said frame for receiving a meat product thereon and transporting it into and through said device;
an upper pressing conveyor belt having forward and rearward ends, said upper pressing conveyor belt mounted on said frame spaced from and above said lower conveyor belt, said upper pressing conveyor belt and said lower conveyor belt cooperating such that when a meat product on said lower conveyor belt is transported into said device, the meat product is compressed between said lower conveyor belt and said upper pressing conveyor belt;
a rotating blade mounted on said frame, said rotating blade having a cutting edge interposed between said lower conveyor belt and said upper pressing conveyor belt such that as the meat product is moved past said cutting edge of said rotating blade, the meat product is cut by said cutting edge of said rotating blade;
at least one drive means operatively connected to each of said conveyor belts and said rotating blade to drive each of said conveyor belts and said rotating blade to pull the meat product through the device and cut the meat product where said cutting edge of said blade contacts the meat product.

2. The horizontal meat slicer of claim 1 wherein said lower conveyor belt extends forwards of said upper pressing conveyor belt such that the meat product is placed on the forward end of said lower conveyor belt for slicing thereof.

3. The horizontal meat slicer of claim 1 wherein said rotating blade comprises a generally circular meat slicing butterfly blade mounted on said frame intermediate said upper pressing and lower conveyor belts and positioned adjacent one side of said upper pressing and lower conveyor belts whereby meat product being drawn through said horizontal meat slicer is cut by said butterfly blade along a portion thereof thereby butterfly slicing the meat product.

4. A horizontal meat slicer comprising:
a frame having forward and rearward ends;
an lower conveyor belt having forward and rearward ends, said lower conveyor bolt mounted on said frame for receiving a meat product thereon and transporting it into and through said device;
an upper pressing conveyor belt having forward and rearward ends, said upper pressing conveyor belt mounted on said frame spaced from and above said lower conveyor belt, said upper pressing conveyor belt and said lower conveyor belt cooperating such that when a meat product on said lower conveyor belt is transported into said device, the meat product is compressed between said lower conveyor belt and said upper pressing conveyor belt;
a generally circular meat slicing butterfly blade mounted on said frame intermediate said upper pressing and lower conveyor belts and positioned adjacent one side of said upper pressing and lower conveyor belts whereby meat product being drawn through said horizontal meat slicer is cut by said butterfly blade along a portion thereof thereby butterfly slicing the meat product;
at least one drive means operatively connected to each of said conveyor belts and said butterfly blade to drive each of said conveyor belts and said butterfly blade to pull the meat product through the device and cut the meat product where said cutting edge of said butterfly blade contacts the meat product.
